(19) United States
(12) Patent Application Publication
(10) Pub. No.: US 2026/0154697 A1
(43) Pub. Date: Jun. 4, 2026

(54) MANAGEMENT AND SECURITY SYSTEMS FOR ARTIFICIAL INTELLIGENCE APPLICATIONS

(71) Applicant: Singulr AI, Inc., Palo Alto, CA (US)

(72) Inventors: Madan Singhal, Pune (IN); Abhijit Sharma, Pune (IN); Shiv Agarwal, Saratoga, CA (US); Deepak Gangwar, Uttar Pradesh (IN); Abhishek Prashant Shingane, Maharastra (IN); Saksham Bhushan, Lucknow (IN)

(21) Appl. No.: 18/969,028

(22) Filed: Dec. 4, 2024

(51) Int. Cl. G06Q 30/018

(52) U.S. Cl. CPC G06Q 30/018

(57) ABSTRACT

A method, includes obtaining a plurality of data items from at least one data source implementing one or more artificial intelligence based (AI-based) services. The method also includes identifying linkages between two or more data items of the plurality of data items. The linkages between the two or more items are based on a confidence score associated with an AI-based service of the one or more AI-based services and indicate a shared association with the AI-based service of the one or more AI based services. The method further includes identifying one or more schema associated with the two or more data items. In addition, the method includes generating an AI security graph associated with the AI-based service according to the one or more schema.

### BACKGROUND

Rapid advancement and widespread adoption of generative artificial intelligence (AI) technologies have brought about a new era of innovation and productivity. However, this advancement and widespread adoption of generative AI technologies has also introduced unprecedented challenges in governance and compliances, security, cost management, and responsible usage of AI technology.

### BRIEF DESCRIPTION OF DRAWINGS

FIG. 1 illustrates an example of an artificial intelligence (AI) artifact and management system, according to at least one embodiment;

FIG. 2 illustrates an example of data sources, a data gathering and processing system, an infrastructure system of an artificial intelligence (AI) artifact and management system, according to at least one embodiment;

FIG. 3 illustrates an example of an infrastructure system and a consumption and governance system of an artificial intelligence (AI) artifact and management system, according to at least one embodiment;

FIG. 4 illustrates an example method of generating AI security graphs, according to at least one embodiment;

FIG. 5 illustrates an example platform for implementing an AI trust feed, according to at least one embodiment;

FIG. 6 illustrates an example generative AI pipeline for implementing with an AI trust feed, according to at least one embodiment;

FIG. 7 illustrates an example AI service discovery method for implementing with an AI trust feed, according to at least one embodiment;

FIG. 8 illustrates an example 3^{rd} party AI SaaS vendor discovery method for implementing with an AI trust feed, according to at least one embodiment;

FIG. 9 illustrates an example large language model (LLM) and metadata discovery method for implementing with an AI trust feed, according to at least one embodiment;

FIG. 10 illustrates an example cloud AI security graph, according to at least one embodiment;

FIG. 11 illustrates an example endpoint AI security graph, according to at least one embodiment;

FIG. 12 is a block diagram illustrating an example computing device that may be used in at least some embodiments.

### DETAILED DESCRIPTION

For AI technologies, high degrees of data sprawl, hints spread across different environments, logs, products to discover and build a comprehensive picture of AI posture and then provide features like governance, cost, and analytics are challenges to be addressed. As described herein, unique designs and architectures involving innovative core schema, optimized data gathering, flexible connecting data silos, agentless discovery and management, dynamic data processors, and/or the like may be used to address these challenges.

Generative AI may include a type of artificial intelligence that creates new content, such as text, images, music, or even videos, by learning patterns from existing data. Unlike traditional AI, which might focus on classification or prediction, generative AI generates original outputs based on the input it receives. An example of generative AI may include text generation, such as GPT, that writes essays, stories, and/or answers questions. Another example of generative AI may include image creation, such as DALL-E, that generates images from textual descriptions. Yet another example of generative AI may include music composition that creates music pieces by analyzing existing compositions. Generative AI may have applications in various fields, including entertainment, marketing, education, and more, enabling creativity and automation in content production.

Creating a comprehensive picture of AI posture presents many different challenges including siloed data, varied and highly connected data, massive volume of data, confidence levels, use case diversity, and/or easy consumption. Siloed data may include information that is fragmented or siloed. Siloed data's value may be found in connecting data across the silos. However, linking the data across the silos sourced from different data sources may be challenging as the identification (ID) systems, property naming, and values differ. Also, linkage through complex workflows (for example, pipelines) may transform artefacts so that tracking the linking information may be difficult. For example, it may be difficult to link a large language model (LLM) deployed in a machine learning (ML) platform to datasets and other models (for example, lineage) present in both a customer environment and ML repositories.

Varied and highly connected data may also present challenges. For example, the nature of information may be varied, for example, consisting of runtime data like network logs (for example, to discover AI and its activity), inventory data, unstructured data (for example, prompt exchanges, data sets), user and application activity data, and/or ML data flows. Connecting these different information types with varying rate of change, type of data, ID schema and property schema, and/or time awareness may be complex. Moreover, an overall connected graph may need to be built incrementally with increasing confidence as more data sources are brought online. For example, for incremental varied and high connected data, an extended direction and response (XDR) data source may help track endpoint AI activity and create a minimal user representation. For instance, for a post addition of a single sign-on data source (for example, Okta), a rich user representation may be added to a graph enriching the model. As another instance, a docker image may be scanned when some AI related activity is observed and deeper information may be gathered that could help discover more attributes of the AI assets. These may be linked to other aspects such as software vulnerabilities and risks. Varied and connected data may include AI data flows from network logs and cloud audit logs and workloads flows from inventory. Varied and connected data may also include unstructured data like prompt exchanges and application and model linking. Varied and connected data may be discovered from content (for example, HTTP AI requests). In at least one embodiment, linking ML infra assets, ML assets, vulnerabilities, data flows, and data assets to create comprehensive AI security graph may be complex.

A volume of information for collection and processing may also be a challenge. For example, huge amounts of data may be collected and processed from various places such as cloud environments, authorized providers, logs, and the like. In order to support the large volume of data, processing may be effective, efficient, and timely. Collected and processed data should also be amenable to joining with other high value data types that form part of the AI security graph. Some examples may include network and cloud audit logs joined with assets to create significant AI data flows. Some examples may also include endpoint activity logs joined with users to evaluate riskiness scores and/or activities.

Determining and/or formulating information confidence levels may be a challenge. Confidence levels associated with various signals and/or data stream types may varies. For example, a system may need to use various data points collected (for example, as hints) (for example, with confidence levels) and infer computed confidence values in an overall connected graph. In at least one embodiment, no data may be present when a virtual machine (VM) hosts an ML model but various collected data points (for example, hints) such as graphic processing unit (GPU) signatures, application programming interface (API) signatures/patterns, resource usage patterns, and/or the like may provide a suggestion or a hint about data confidence levels. User feedback concerning information confidence(s) may also be included.

In at least one embodiment, another challenge relates to use-case diversity. For example, risk, policy, compliance, workflows, trending, all may need flexible consumption mechanisms. Flexible AI Graph Query Layer-Metadata driven, Flexible (to support new use cases). Easy consumption: The security use cases to be built on top of this complex, connected and diverse (structured, unstructured, highly relational, mix of data and assets and activity) graph needs to be highly consumable. This necessitates a generative AI native natural language interface and a very flexible policy framework.

In at least one embodiment, yet another challenge relates to an ease of consuming information in view of security. For example, security use cases may be built on top of complex, connected, and/or diverse data (for example, structured data, unstructured data, high relational data, a mix of data types, a mix of data assets, and/or a mix of activity). However, because of security needs, it may be a challenge to consume the data. In at least one embodiment, a generative AI natural language interface may be used with a flexible policy framework.

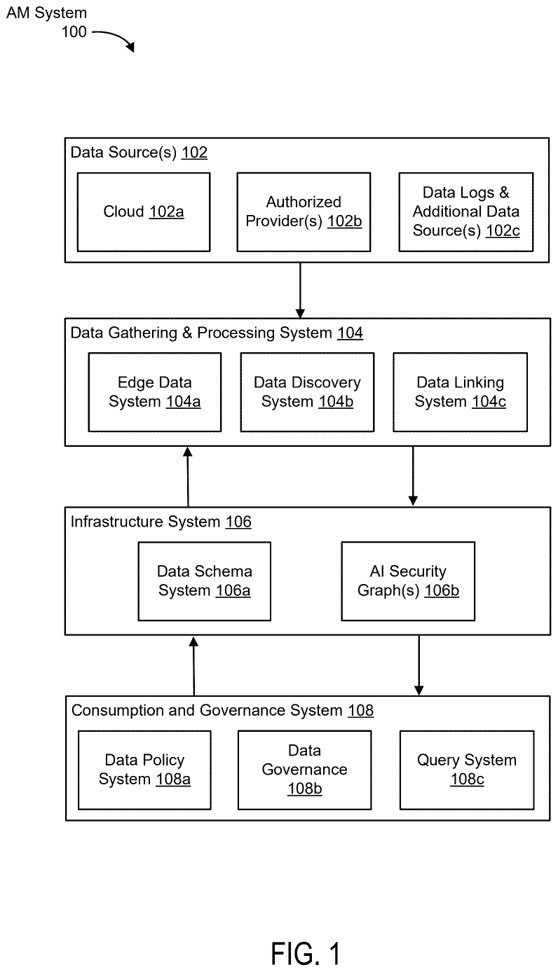

To address the aforementioned problems, an artificial intelligence (AI) artifact and management system (for example, an artifact and management (AM) system, AM platform) may be implemented. AM system may provide a comprehensive solution in building a complete AI posture of organization and may provide governance and a user-friendly consumer interface. FIG. 1 illustrates an example of an artificial intelligence (AI) artifact and management system 100 (for example, AM system 100), according to at least one embodiment. As shown in FIG. 1, the AM system 100 may include data source(s) 102, a data gathering and processing system 104, an infrastructure system 106, and a consumption and governance system 108. The data gathering and processing system 104 may obtain data (for example, siloed data) from various data sources 102 and may attach one or more categorization(s) to the data to make sense of the data. The consumption and governance system 108 may be responsible for providing intuitive processes to query stored data and may provide processes to create and validate policies for governance. The infrastructure 106 may support the data gathering and processing system 104 and the consumption and governance system 108, for example, using data schema and AI security graph(s).

As described herein, the data gathering and processing system 104 may obtain data (for example, siloed data) from various data sources 102 and may attach one or more categorization(s) to the data to make sense of the data. The Data gathering and processing system 104 may, via edge processing, obtain (for example, fetch, retrieve, receive) data from a plurality of data sources 102 (for example, a plurality of different data sources). Edge processing may include “seed based processing” and “optimization: local aggregation/sampling.” For example, as described herein, the plurality of data sources 102 may include data from a cloud network, data from authorized providers, and/or data from logs and other data sources. Upon obtaining the data from the plurality of data sources 102, the data gathering and processing system 104 may collect the data, processes the data, and forward the data with a view to collect multiple pieces of data (for example, signal(s)) in an optimized manner. In at least one embodiment, the data gathering and processing system 104 may collect multiple, high volume, varied data across different silos and may ensure processing (for example, processing power, processing costs) is proportionate to a particular use case. For example, the data gathering and processing system 104 may implement seeding to optimize AI activity, inventory data collection, and/or dispatch flows. For instance, the data gathering and processing system 104 may provide data fetchers that obtain data from one or more particular data source(s) (for example, necessary data, necessary information) to filter the data from a respective data source 102. The data gathering and processing system 104 may include a Domain Name System (DNS) logs obtainer provided with DNS(s) for all AI services for obtaining records of only those uniform resource locator(s) (URL(s)). A DNS logs obtainer provided with DNS(s) for all AI services for obtaining records of only those URL(s) may limit an amount of data obtained from a particular data source 102. The data gathering and processing system 104 may seed the obtained data for customized filtering. For instance, data gathering and processing system 104 may initially obtain a restricted set of data. Subsequently, data gathering and processing system 104 may seed additionally obtained data based on the previously obtained restricted set of data. This allows the data gathering and processing system 104 to formulate and attach relationships or linkages of the obtained data for reducing and/or minimizing a volume of obtained data for use by AM system 100. For example, the data gathering and processing system 104 may drop all network data flows until a generative AI VM is identified based on the DNS data signal. Subsequently, the data gathering and processing system 104 may start obtaining or collecting data flow for the generative AI VM and its respective neighbors (for example, for a limited or predetermined number of hops). Upon the data gathering and processing system 104 obtaining the data from the data sources 102, the data gathering and processing system 104 may optimize and aggregate the obtained data. For example, the data gathering and processing system 104 may filter out obtained duplicate data from the data sources 102 for a predetermined amount of time and aggregate the obtained data (for example, the raw data) obtained over a predetermined amount of time for further processing so that less than all of the obtained data is for designated for further processing.

The data gathering and processing system 104 may also, via a discovery service, consume all of the collected varied data streams from the plurality of data sources 102, and use the data streams for linking the data and populating one or more AI security graphs. Discovery service may include “Discovery pipeline,” “Hints based Discovery and Framework,” and “Dynamic content based discovery.” The data gathering and processing system 104 may use signals to attached hints (for example, data points) with confidence scores to nodes and edges for incrementally enhancing AI security graph(s). The data gathering and processing system 104 may use dynamic content, configuration extraction, and mapping from AI services for AI service signature discovery.

The data gathering and processing system 104 may further, via a linking service, use data processing pipelines from the discovery service to populate AI security graph(s) from the incoming diverse data streams. Linking service may include “Linking entities in the generative AI security graph based on rules and/or fuzzy matching.” The data gathering and processing system 104 may implement entity linking (for example, entity matching) from multiple data sources 102 to trust feed between entity types. The data gathering and processing system 104 may assign IDs (for example, imperfect IDs), names, and/or references (for example, reference numbers) for data from each of the data streams. The data gathering and processing system 104 may link data based on traversal rules between entities. The data gathering and processing system 104 may implement fuzzy linking of entities based on respective names and respective property embeddings. The data gathering and processing system 104 may provide multiple different methods of representing a same entity. The data gathering and processing system 104 may track or trace AI artifacts, for example, by making binary copies from HF to S3 to pipeline to model in SM.

As described herein, the consumption and governance system 108 may be responsible for providing intuitive processes to query stored data and may provide processes to create and validate policies for governance. The consumption and governance system 108 may, via a policy service, provide a policy framework. For example, the consumption and governance system 108 may implement robust policy frameworks, for example, based on schema. As another example, the consumption and governance system 108 policies may be generated using natural language.

The consumption and governance system 108 may also, via a governance service, provide a governance and natural language interface. An AI governance layer implement a governance service may include “governance trends (such as schema driven governance trends).” For example, the consumption and governance system 108 may obtain AI policy descriptions (for example, High Level AI policy descriptions) to generative AI policy extraction(s). The consumption and governance system 108 may see a trend of any property along with applied property filters. This may help validate AI governance, for example, such that trends of high risk AI service may decrease over time. The consumption and governance system 108 may use AI policies to govern generative AI assets, generative Ai runtime, generative AI data flows, and/or prompts and completions. The consumption and governance system 108 may use AI policies to evaluate security information, risk, relationships between assets, runtime, data flows, and/or prompts/completions. Use cases may be build on top of the consumption and governance system 108.

The consumption and governance system 108 may further, via a query service (for example, semantic query service), utilize semantic queries. In at least one embodiment, an AI posture query layer for implementing a query service may include an “AI posture assistant: NL interface” and “schema driven graph retrieval.” In at least one embodiment, through a semantic query, the consumption and governance system 108 may perform generative AI inventory searches. For instance, the consumption and governance system 108 may search for semantic content, AI asset and runtime infrastructure graph(s), data flows, and/or generative AI activity data such as token and prompts. In at least one embodiment, through a semantic query, the consumption and governance system 108 may use generative AI schema for obtaining (for example, fetching) data using natural language queries and/or may fetch all user that are using high risk AI services.

As described herein, the infrastructure 106 may support the data gathering and processing system 104 and the consumption and governance system 108, for example, using data schema and AI security graph(s). In at least one embodiment, the infrastructure 106 may, via a schema service, may formulate rich schema, for example using natural language hints associated with entities, relationship, properties, and/or policies, for every entity type in generative AI attributes of individual entities and respective relationships to other entities for generating a graph-like schema. AI schema service, policy framework may include “policy translation (from a high level description).” The infrastructure 106 may use schema embedded in all workflows including consumption, policy enforcement, data collection, linking of entities, and/or natural language querying. For example, the infrastructure 106 may automatically extract trends over a period of time from configuration properties and/or schema relationships. The infrastructure 106 may see trends of any property along with applied property filters to help validation of AI governance such as a trend of a high risk AI service going down over time. The infrastructure 106 may enable natural language based use cases. For example, the infrastructure 106 may enable fuzzy linking of entities based on a name embeddings and/or property embeddings. As another example, the infrastructure 106 may map and extract natural language to an entity from a text description such as extracting structure policy types from a user entered policy text description.

In at least one embodiment, the infrastructure 106 may, using AI security graph(s), capture a core underlying graph of the AI assets, AI relationship assets, underlying ML model, compute and data infrastructure, data flows, risks, and/or vulnerabilities. The infrastructure 106 may collect data from a pipeline and provide the data to a discovery service for populating and maintaining AI security graph(s). The infrastructure 106 may enable high value capabilities that help implement policies, compute risks, attach vulnerabilities, track risky data flows, capture relationships (for example, model lineage) for enabling rich AI posture functionality.

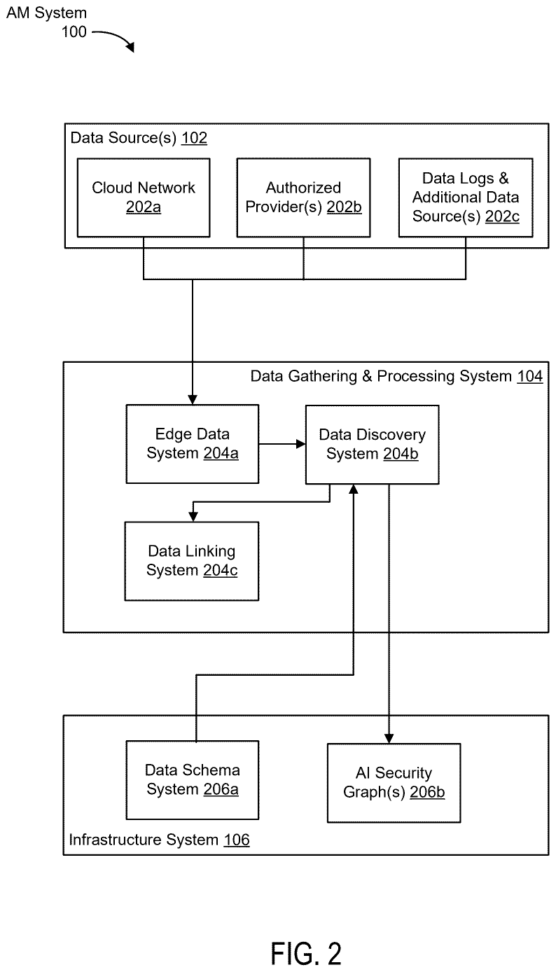

FIG. 2 illustrates an example of data sources 102, a data gathering and processing system 104, and an infrastructure system 106 of an artificial intelligence (AI) artifact and management system 100, according to at least one embodiment. FIG. 2 may illustrate data gathering and processing components of AM system 100. As shown in FIG. 2, the AM system 100 may include data source(s) 102, a data gathering and processing system 104, an infrastructure system 106, and a consumption and governance system 108. As described herein, the data gathering and processing system 104 may obtain data (for example, siloed data) from the data sources 102 and may attach one or more categorization(s) to the data to make sense of the data. The consumption and governance system 108 may be responsible for providing intuitive processes to query stored data and may provide processes to create and validate policies for governance. The infrastructure 106 may support the data gathering and processing system 104 and the consumption and governance system 108, for example, using data schema and AI security graph(s).

The data sources 102 may include a cloud network 202a, one or more authorized provider(s) 202b, and/or data logs and additional data source(s) 202c. The data gathering and processing system 104 may include an edge data system 204a, a data discovery system 204b, and a data linking system 204c. As described herein, the edge data system 204a may obtain data (for example, siloed data) from various data sources 102 and may attach one or more categorization(s) to the data to make sense of the data. The edge data system 204a may obtain (for example, fetch, retrieve, receive) data from a plurality of data sources 102 (for example, a plurality of different data sources). The edge data system 204a may implement edge processing including “seed based processing” and “optimization: local aggregation/sampling.” For example, as described herein, the plurality of data sources 102 may include data from a cloud network 202a, data from authorized providers 202b, and/or data from logs and other data sources 202c. Upon obtaining the data from the plurality of data sources 102, the edge data system 204a may collect the data, processes the data, and forward the data to the data discovery system 204a with a view to collect multiple pieces of data (for example, signal(s)) in an optimized manner. In at least one embodiment, the edge data system 204a may collect multiple, high volume, varied data across different silos and may ensure processing (for example, processing power, processing costs) is proportionate to a particular use case. For example, the edge data system 204a may implement seeding to optimize AI activity, inventory data collection, and/or dispatch flows. For instance, the edge data system 204a may provide data fetchers that obtain data from one or more particular data source(s) 102 (for example, necessary data, necessary information) to filter the data from a respective data source 102. The edge data system 204a may include a Domain Name System (DNS) logs obtainer provided with DNS(s) for all AI services for obtaining records of only those uniform resource locator(s) (URL(s)). A DNS logs obtainer provided with DNS(s) for all AI services for obtaining records of only those URL(s) may limit an amount of data obtained from a particular data source 102. The edge data system 204a may seed the obtained data for customized filtering. For instance, the edge data system 204a may initially obtain a restricted set of data. Subsequently, the edge data system 204a may seed additionally obtained data based on the previously obtained restricted set of data. This allows the edge data system 204a to formulate and attach relationships or linkages of the obtained data for reducing and/or minimizing a volume of obtained data for use by AM system 100. For example, the edge data system 204a may drop all network data flows until a generative AI VM is identified based on the DNS data signal. Subsequently, the edge data system 204a may start obtaining or collecting data flow for the generative AI VM and its respective neighbors (for example, for a limited or predetermined number of hops). Upon the edge data system 204a obtaining the data from the data sources 102, the edge data system 204a may optimize and aggregate the obtained data. For example, the edge data system 204a may filter out obtained duplicate data from the data sources 102 for a predetermined amount of time and aggregate the obtained data (for example, the raw data) obtained over a predetermined amount of time for further processing so that less than all of the obtained data is for designated for further processing.

The data gathering and processing system 104 may include the data discovery service 204b. The data discover service 204b may consume all of the collected varied data streams from the plurality of data sources 102, and use the data streams for linking the data and populating one or more AI security graphs. The data discover service 204b may implement a discovery service that includes “Discovery pipeline,” “Hints based Discovery and Framework,” and “Dynamic content based discovery.” The data discover service 204b may use signals to attached hints (for example, data points) with confidence scores to nodes and edges for incrementally enhancing AI security graph(s). The data discover service 204b may use dynamic content, configuration extraction, and mapping from AI services for AI service signature discovery.

The data gathering and processing system 104 may further include the data linking system 204c. The data linking system 204c may use data processing pipelines from the data discovery system 204b to populate AI security graph(s) from the incoming diverse data streams. The data linking system 204c may implement a linking service that may include “Linking entities in the generative AI security graph based on rules and/or fuzzy matching.” The data linking system 204c may implement entity linking (for example, entity matching) from multiple data sources 102 to a trust feed between entity types. The data linking system 204c may assign IDs (for example, imperfect IDs), names, and/or references (for example, reference numbers) for data from each of the data streams. The data linking system 204c may link data based on traversal rules between entities. The data linking system 204c may implement fuzzy linking of entities based on respective names and respective property embeddings. The data linking system 204c may provide multiple different methods of representing a same entity. The data linking system 204c may track or trace AI artifacts, for example, by making binary copies from HF to S3 to pipeline to model in SM.

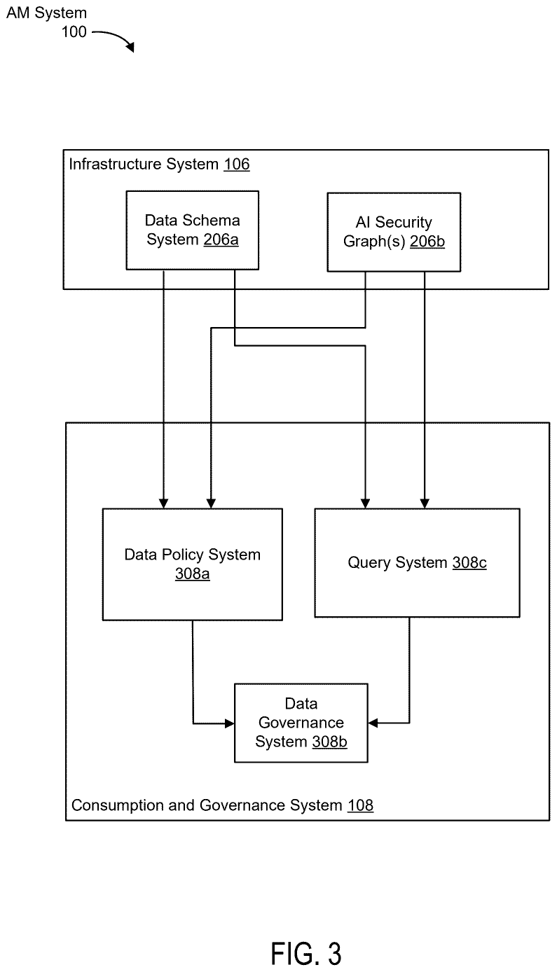

FIG. 3 illustrates an example of an infrastructure system 106 and a consumption and governance system 108 of an artificial intelligence (AI) artifact and management system 100, according to at least one embodiment. The consumption and governance system 108 may include a data policy system 308a, a data governance system 308b, and a query system 308c. The consumption and governance system 108 may be responsible for providing intuitive processes to query stored data and may provide processes to create and validate policies for governance. In at least one embodiment, the data policy system 308a may implement a policy service to provide a policy framework. For example, the data policy system 308a may implement robust policy frameworks, for example, based on schema received from the data schema system 206a of the infrastructure system 106. As another example, the data policy system 308a may generate policies using natural language.

The data governance system 308b may implement a governance service to provide data governance and a natural language interface. A data governance system 308a (for example, an AI governance layer) implementing a governance service may include “governance trends (such as schema driven governance trends).” For example, the data governance system 308b may obtain AI policy descriptions (for example, High Level AI policy descriptions) to generative AI policy extraction(s). The data governance system 308b may see a trend of any property along with applied property filters. This may help validate AI governance, for example, a trend of a high risk AI service decreasing over time. The consumption and governance system 108 may use AI policies to govern generative AI assets, generative Ai runtime, generative AI data flows, and/or prompts and completions. The consumption and governance system 108 may use AI policies to evaluate security information, risk, relationships between assets, runtime, data flows, and/or prompts/completions. Use cases may be built on top of the consumption and governance system 108.

The consumption and governance system 108 may further include a query system 308c for implementing a query service (for example, semantic query service), that utilizes semantic queries. In at least one embodiment, an AI posture query layer for implementing a query service may include an “AI posture assistant: NL interface” and “schema driven graph retrieval.” In at least one embodiment, the query system 308c may perform generative AI inventory searches. For instance, the query system 308c may search for semantic content, AI asset and runtime infrastructure graph(s), data flows, and/or generative AI activity data such as token and prompts. In at least one embodiment, the query system 308c may use generative AI schema for obtaining (for example, fetching) data using natural language queries and/or may fetch all user that are using high risk AI services.

As described herein, the infrastructure 106 may support the data gathering and processing system 104 and the consumption and governance system 108, for example, using data schema and AI security graph(s). In at least one embodiment, the infrastructure 106 may include a data schema system 206a implementing a schema service that may formulate rich schema, for example using natural language hints associated with entities, relationship, properties, and/or policies, for every entity type in generative AI attributes of individual entities and respective relationships to other entities for generating a graph-like schema. AI schema service, policy framework may include “policy translation (from a high level description).” The data schema service 206a may use schema embedded in all workflows including consumption, policy enforcement, data collection, linking of entities, and/or natural language querying. For example, the data schema service 206a may automatically extract trends over a period of time from configuration properties and/or schema relationships. The data schema service 206a may see trends of any property along with applied property filters to help validation of AI governance such as a trend of a high risk AI service going down over time. The data schema service 206a may enable natural language based use cases. For example, the data schema service 206a may enable fuzzy linking of entities based on a name embeddings and/or property embeddings. As another example, the data schema service 206a may map and extract natural language to an entity from a text description such as extracting structure policy types from a user entered policy text description.

In at least one embodiment, the infrastructure 106 may include AI security graph(s) 206b to capture a core underlying graphs of the AI assets, AI relationship assets, underlying ML model, compute and data infrastructure, data flows, risks, and/or vulnerabilities. The AI security graph(s) 206b may collect data from a pipeline and provide the data to a discovery service for populating and maintaining AI security graph(s). The AI security graph(s) 206b may enable high value capabilities that help implement policies, compute risks, attach vulnerabilities, track risky data flows, capture relationships (for example, model lineage) for enabling rich AI posture functionality.

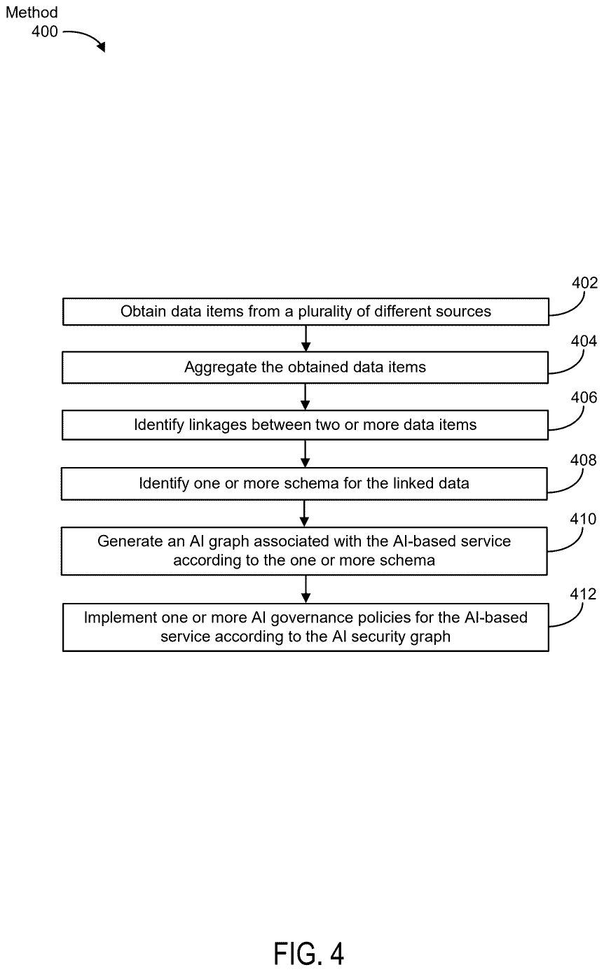

FIG. 4 illustrates an example method 400 of generating AI security graphs, according to at least one embodiment. The method 400 may be implemented by the AM system 100 illustrated in FIGS. 1, 2, and 3. At step 402, the AM system 100 may obtain data (for example, siloed data) from various data sources 102. For instances, the AM system 100 may obtain a plurality of data items from at least one data source implementing one or more artificial intelligence based (AI-based) services. For example, the AM system 100 may obtain data from various sources and may attach one or more categorization(s) to the data to make sense of the data. The AM system 100 may, via edge processing, obtain (for example, fetch, retrieve, receive) data from a plurality of data sources 102 (for example, a plurality of different data sources). Edge processing may include “seed based processing” and “optimization: local aggregation/sampling.” For example, as described herein, the plurality of data sources 102 may include data from a cloud network, data from authorized providers, and/or data from logs and other data sources. Upon obtaining the data from the plurality of data sources 102, the AM system 100 may collect the data, processes the data, and forward the data with a view to collect multiple pieces of data (for example, signal(s)) in an optimized manner. In at least one embodiment, the AM system 100 may collect multiple, high volume, varied data across different silos and may ensure processing (for example, processing power, processing costs) is proportionate to a particular use case. For example, the AM system 100 may implement seeding to optimize AI activity, inventory data collection, and/or dispatch flows. For instance, the AM system 100 may provide data fetchers that obtain data from one or more particular data source(s) (for example, necessary data, necessary information) to filter the data from a respective data source 102. The AM system 100 may include a Domain Name System (DNS) logs obtainer provided with DNS(s) for all AI services for obtaining records of only those uniform resource locator(s) (URL(s)). A DNS logs obtainer provided with DNS(s) for all AI services for obtaining records of only those URL(s) may limit an amount of data obtained from a particular data source 102.

In at least one embodiment, the AM system 100 may seed the obtained data for customized filtering. For instance, the AM system 100 may initially obtain a restricted set of data. Subsequently, the AM system 100 may seed additionally obtained data based on the previously obtained restricted set of data. This allows the AM system 100 to formulate and attach relationships or linkages of the obtained data for reducing and/or minimizing a volume of obtained data for use by AM system 100. For example, the AM system 100 may drop all network data flows until a generative AI VM is identified based on the DNS data signal. Subsequently, the AM system 100 may start obtaining or collecting data flow for the generative AI VM and its respective neighbors (for example, for a limited or predetermined number of hops).

At step 404, upon the AM system 100 obtaining the data from the data sources 102, the AM system 100 may aggregate (and, for example, optimize) the obtained data. For example, the AM system 100 may filter out obtained duplicate data from the data sources 102 for a predetermined amount of time and aggregate the obtained data (for example, the raw data) obtained over a predetermined amount of time for further processing so that less than all of the obtained data is for designated for further processing.

At step 406, the AM system 100 may also identify linkages between two or more data items from a data source. For instance, the AM system 100 may identify linkages between two or more data items of the plurality of data items, wherein the linkages between the two or more items are based on a shared association with an AI-based service of the one or more AI based services. In at least one embodiment, the AM system 100 may identify the linkages between the two or more data items comprises receiving a restricted set of data items and subsequently seeding the two or more data items based on the restricted set of data items. At step 408, the AM system 100 may further identify linkages between two or more data items from different data sources of the plurality of data sources. For example, based on the seeding of the data, the AM system 100 may link data from one data sources with data from one or more other data sources. For instance, the AM system 100 may also, via a discovery service, consume all of the collected varied data streams from the plurality of data sources 102, and use the data streams for linking the data and populating one or more AI security graphs. Discovery service may include “Discovery pipeline,” “Hints based Discovery and Framework,” and “Dynamic content based discovery.”

As described herein, the infrastructure 106 of the AM system 100 may support the data gathering and processing system 104 of the AM system 100 and the consumption and governance system 108 of the AM system 100, for example, using data schema and AI security graph(s). At step 408, the AM system 100 may formulate schema for the data obtained from the plurality of data sources 102. In at least one embodiment, the schema may include at least one of consumption workflows associated with the AI-based service, policy enforcement workflows associated with the AI-based service, data collection workflows associated with the AI-based service, entity linking associated with the AI-based service, or natural language querying associated with the AI-based service. For example, the AM system 100 may identify one or more schema associated with the two or more data items. For instance, the AM system 100 may, via a schema service, formulate rich schema, for example using natural language hints associated with entities, relationship, properties, and/or policies, for every entity type in generative AI attributes of individual entities and respective relationships to other entities for generating a graph-like schema. AI schema service, policy framework may include “policy translation (from a high level description).” The AM system 100 may use schema embedded in all workflows including consumption, policy enforcement, data collection, linking of entities, and/or natural language querying. For example, the AM system 100 may automatically extract trends over a period of time from configuration properties and/or schema relationships. The AM system 100 may see trends of any property along with applied property filters to help validation of AI governance such as a trend of a high risk AI service going down over time. The AM system 100 may enable natural language based use cases. For example, the AM system 100 may enable fuzzy linking of entities based on a name embeddings and/or property embeddings. As another example, the AM system 100 may map and extract natural language to an entity from a text description such as extracting structure policy types from a user entered policy text description.

In at least one embodiment, the AM system 100 may attach confidence scores to nodes associated with the linked data. For example, the AM system 100 may use signals to attached hints (for example, data points) with confidence scores to nodes and edges for incrementally enhancing AI security graph(s). The AM system 100 may use dynamic content, configuration extraction, and mapping from AI services for AI service signature discovery.

At step 410, the AM system 100 may generate an AI graph associated with an AI asset based on schema of linked data. For example, the AM system 100 may generate an AI security graph associated with the AI-based service according to the one or more schema. For instance, the AM system 100 may, using AI security graph(s), capture a core underlying graph of the AI assets, AI relationship assets, underlying ML model, compute and data infrastructure, data flows, risks, and/or vulnerabilities. The AM system 100 may collect data from a pipeline and provide the data to a discovery service for populating and maintaining AI security graph(s). The AM system 100 may enable high value capabilities that help implement policies, compute risks, attach vulnerabilities, track risky data flows, capture relationships (for example, model lineage) for enabling rich AI posture functionality.

The AM system 100 may further, via a linking service, use data processing pipelines from the discovery service to populate AI security graph(s) from the incoming diverse data streams. Linking service may include “Linking entities in the generative AI security graph based on rules and/or fuzzy matching.” The AM system 100 may implement entity linking (for example, entity matching) from multiple data sources 102 to an AI trust feed between entity types. The AM system 100 may assign IDs (for example, imperfect IDs), names, and/or references (for example, reference numbers) for data from each of the data streams. The AM system 100 may link data based on traversal rules between entities. The AM system 100 may implement fuzzy linking of entities based on respective names and respective property embeddings. The AM system 100 may provide multiple different methods of representing a same entity. The AM system 100 may track or trace AI artifacts, for example, by making binary copies from HF to S3 to pipeline to model in SM.

At step 412, the AM system 100 may implement one or more AI governance policies for the AI-based service according to the AI security graph. In at least one embodiment, the AM system 100 may implement one or more governance policy based on the confidence scores and the linked data. As described herein, the AM system 100 may be responsible for providing intuitive processes to query stored data and may provide processes to create and validate policies for governance. The AM system 10 may, via a policy service, provide a policy framework. For example, the AM system 100 may implement robust policy frameworks, for example, based on schema. As another example, the AM system 100 policies may be generated using natural language.

The AM system 100 may also, via a governance service, provide a governance and natural language interface. An AI governance layer implementing a governance service may include “governance trends (such as schema driven governance trends).” For example, the AM system 100 may obtain AI policy descriptions (for example, High Level AI policy descriptions) to generative AI policy extraction(s). The AM system 100 may see a trend of any property along with applied property filters. This may help validate AI governance, for example, such that trends of high risk AI services may decrease over time. The AM system 100 may use AI policies to govern generative AI assets, generative AI runtime, generative AI data flows, and/or prompts and completions. The AM system 100 may use AI policies to evaluate security information, risk, relationships between assets, runtime, data flows, and/or prompts/completions.

In at least one embodiment, the AM system 100 may receive a query. For example, the AM system 100 may further, via a query service (for example, semantic query service), utilize semantic queries. In at least one embodiment, an AI posture query layer for implementing a query service may include an “AI posture assistant: NL interface” and “schema driven graph retrieval.” In at least one embodiment, through a semantic query, the AM system 100 may perform generative AI inventory searches. For instance, the AM system 100 may search for semantic content, AI asset and runtime infrastructure graph(s), data flows, and/or generative AI activity data such as token and prompts. In at least one embodiment, through a semantic query, the AM system 100 may use generative AI schema for obtaining (for example, fetching) data using natural language queries and/or may fetch all user that are using high risk AI services.

As previously mentioned herein, the rapid advancement and widespread adoption of generative AI technologies have ushered in a new era of innovation and productivity, but this growth has also brought significant challenges in areas like governance, compliance, security, cost management, and the responsible usage of AI. In response to these challenges, the AI trust feed may offer a comprehensive platform for monitoring and analyzing generative AI artifacts and usage signatures. An AI trust feed platform may be designed to unify the management of AI models, datasets, and services, while providing crucial insights into the security risks AI poses to enterprises. By consolidating information on AI artifacts and tracking usage patterns, the AI Trust Feed aims to empower organizations to make informed decisions, mitigate potential threats, and optimize their AI investments. Our research explores the architecture, functionality, and potential impact of the AI Trust Feed in enhancing AI governance, security, and cost-effectiveness across a range of industries.

The exponential growth of AI model development and deployment has created a complex and rapidly evolving ecosystem that presents significant challenges for organizations. One of the key difficulties is the proliferation of AI services and the need to properly vet these offerings. With hundreds of new generative AI-based software as a service (SaaS) services emerging daily, organizations may encounter challenges in assessing the risks associated with these services and ensuring they meet compliance and security standards. Additionally, the integration of AI in third-party vendor services, such as SLACK™ and WORKDAY™, has introduced further complexity. Many such vendors may be increasingly incorporating AI-driven features in their latest software versions, often enabling these features automatically after upgrades, which exposes proprietary organizational data to additional AI systems operated by third-party entities.

Another challenge is the sheer proliferation of AI models. Thousands of new AI models may be trained every day on various datasets, both public and private, making it difficult for organizations to track their origins and assess potential biases. The widespread sharing and reuse of models through platforms like HUGGING FACE™ has fueled innovation but may have also increased the risk of using models with unknown provenance or hidden vulnerabilities. Moreover, the rapid development of AI services by prompt engineers and software developers using fine-tuned models on popular platforms like AWS BEDROCK™, OPENAI GPT™, and AZURE AI™ often happens without a comprehensive understanding of the models' limitations or potential risks.

Data privacy concerns further complicate the landscape. As employees rely on AI services built on open-source models trained on public datasets, sensitive organizational data may be increasingly exposed to unknown risks. The lack of transparency in the complex chain of model development, fine-tuning, and deployment may also make it difficult to trace the lineage of AI artifacts, which in turn challenges efforts to assess their reliability and security. Additionally, the rapid pace of AI adoption has outpaced the development of regulatory frameworks, leaving organizations vulnerable to potential legal and ethical issues. Security vulnerabilities are also a growing concern. For example, the use of shared models and services may increase the risk of adversarial attacks, such as model poisoning or prompt injections, which may compromise the integrity of AI systems.

Finally, cost management may remain a major hurdle for organizations, which struggle to optimize their AI investments due to limited visibility into model usage patterns and effectiveness across different applications. These interconnected challenges highlight the need for a comprehensive solution like the AI trust feed to streamline AI governance and security while improving overall cost-effectiveness.

The AI trust feed may be a comprehensive approach addressing multiple facets of AI governance, security, and usage. In addition, individual aspects of the challenges may also be solved using the platform. For example, in terms of AI governance and risk management, the AI trust feed may provide a unified solution that consolidates all aspects of AI governance, from model development to deployment. In the area of model and data lineage, AI trust feed may help track machine learning experiments and model versions, and track model sources. AI trust feed may address the challenge of model tracking while monitoring the entire scope of AI artifacts, including datasets and services. As a result, AI trust feed may focus on specific aspects of AI usage while also offering a comprehensive view of the model ecosystem.

When it comes to AI security research, there are numerous studies on adversarial attacks, prompt injections, and model vulnerabilities. The AI trust feed may provide a holistic approach to security monitoring, encompassing a broad range of potential risks. In the context of AI marketplaces, AI trust feed may include built-in mechanisms for comprehensive risk assessment and usage tracking for monitoring and analysis. Another important area is explainable AI, where AI trust feed may make AI models more interpretable and understandable for users, while also contributing to transparency, security challenges, and cost management. By providing interpretability, AI trust feed may ensure the security, cost efficiency, and governance of AI systems. Further, AI auditing tools have emerged as solutions for auditing specific aspects of AI systems, such as fairness and bias. While these tools are valuable for assessing particular concerns, they do not offer a holistic view of AI usage, security, or risks, leaving gaps in overall governance. The AI Trust Feed, in contrast, aims to provide a comprehensive audit trail across multiple dimensions of AI deployment. Finally, in the realm of regulatory compliance frameworks, initiatives like the EU's AI Act or the IEEE's Ethically Aligned Design may provide important guidelines and ethical frameworks for AI development and usage. However, these initiatives primarily focus on setting standards and guidelines rather than offering practical tools for monitoring and managing AI artifacts in real-time. The AI Trust Feed may offer actionable insights and monitoring capabilities to ensure compliance with evolving regulations. In summary, AI trust feed may provide a unified comprehensive platform for monitoring and risk management.

To address the challenges of managing and securing generative AI technologies in enterprises, AI trust feed may be a comprehensive platform designed to analyze and optimize the usage of generative AI tools. The AI Trust Feed may be a unified solution that helps organizations consolidate and examine usage patterns of generative AI across application deployments and endpoints. The AI trust feed may consolidate and analyze generative AI usage signatures, identify and assess risks associated with AI usage, and provide a robust tool for organizations navigating the evolving AI landscape.

The AI trust feed platform is built with three core functionalities in mind. For example, the AI trust feed may dynamically detect newly added AI services and the risks associated with them. Also, the AI trust feed may facilitate the discovery of third-party SaaS vendors and their fourth-party AI services within marketplaces, including the lineage from third-party vendors to fifth-party AI services. Further, AI trust feed may enable the discovery of AI artifacts such as public and private machine learning models (for example, generative AI models such as LLMs), fine-tuned models, and datasets, alongside their data lineage.

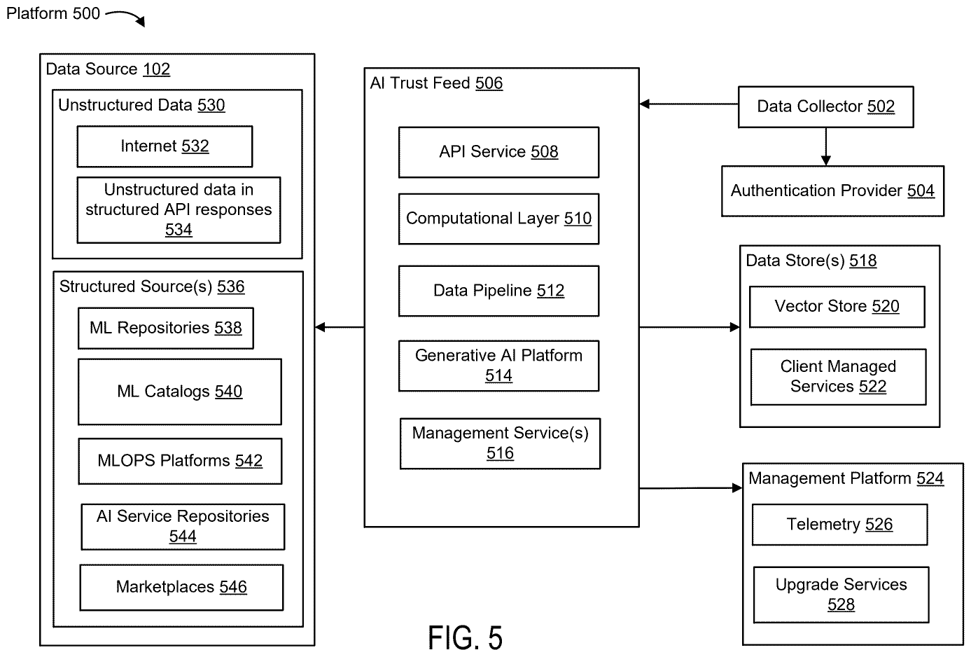

FIG. 5 illustrates an example platform 500 for implementing an AI trust feed, according to at least one embodiment. The platform 500 include a data collector 502, an authentication provider 504, an AI trust feed 506 including API service(s) 508, a computational layer 510, a data pipeline 512, a generative AI platform 514, and management service(s) 516. The platform 500 also includes one or more data store(s) 518 including a vector store 520 and client managed service(s) 522. The platform 500 further includes data source(s) 102 including unstructured data 530 and structured source(s) 536. Unstructured data 530 may include internet data 532 and unstructured data in structured API responses 534. Structure source(s) 536 may include ML repositories 538, ML catalog(s) 540, ML Open-Source Model(s) MLOps platforms 542, AI service repositories 544, and marketplaces 546. The AI trust feed 506 integrates unstructured internet data 532 with structured data from APIs 534. This integration occurs in a secure environment using generative AI platform 514, which coordinates various data processing tasks. The enriched unstructured data 530 is stored in the vector store 520, while other data types are managed in client managed data 522. The processed data undergoes several computational layers for normalization, scanning, and lineage generation.

In at least one embodiment as shown in FIG. 5, the AI trust feed 500 may include the computational layer 510. The computation layer 510 may play a crucial role in managing and accessing various AI services and their associated risks. For example, the computational layer 510 may normalize categories for different AI services and their features. This process involves classifying the features and tasks associated with each AI service to create a risk profile and establish policies tailored to each service. As another example, the computational layer 510 may generate a compliance score that is determined based on an organization's compliance policies and the metadata collected for the AI service. The compliance score may be used to assess how well the service aligns with the necessary regulatory and organizational standards.

In at least one embodiment, the computational layer 510 may also generate or calculate a risk score. The risk score may be calculated based on several factors, including a type of publisher (whether it's a single developer, startup, or large organization), a publisher's background (such as company age, number of employees, and country of origin), and/or a type of data the AI service consumes. For example, an AI service focused on software development may handle code, making it riskier than an AI service that simply schedules meetings from a calendar. The proximity of the AI service to sensitive data also matters; for instance, AI tools integrated within an IDE may be considered riskier than more detached services. The risk score may also consider whether the AI service allows third-party plugins or operates through marketplaces like Chrome extensions and integrated development environments (IDEs), with services that allow such integrations generally being higher risk. Other contributing factors may include the privacy policy, data retention practices, and security best practices followed by the AI service.

The computational layer 510 may also formulate lineage generation for ML models and datasets. For example, the computation layer 510 may use metadata from model and dataset repositories to trace the fine-tuning and usage histories of models and datasets. This may include discovering model lineage, which involves tracking the fine-tuning history (both model and dataset) of publicly available large language models. For example, over 1,000 fine-tuned versions of a single model may be publicly available, and some may have been trained on biased or toxic data. Dataset lineage may also play a role, with publicly available datasets like the datasets being used in over 400 models on platforms. License lineage discovery may also be important to ensure that models are not being used with unknown or proprietary licenses.

In at least one embodiment, the computation layer 510 may provide scanning services for security and quality assurance. These scanning services may assess the security of ML models, docker images, and datasets. They may be used to identify potential risks such as vulnerabilities, toxic data, or inappropriate content that could compromise the integrity or safety of AI applications.

The AI trust feed 500 may enable the creation of powerful AI solutions by aggregating and analyzing data from multiple sources. For example, a developer productivity service which provides code generation and review services, may be accessed via various marketplaces such as IDEs or browser extensions. Each marketplace may have its own deployment policies and permissions, which may vary in terms of access levels. For instance, a service plugin on one service may gain full access to code without requiring any configuration, whereas plugins on another service or extension may have different permission settings. The AI trust feed 500 may be capable of discovering signatures of these AI services across different marketplaces, ensuring comprehensive tracking and risk assessment.

The AI trust feed 500 may aggregate data from diverse and reputable sources, including repositories, academic papers, and popular GitHub repositories. A specific example of this is the open-source model “finance-LLM,” deployed on a variety of platforms. The AI trust feed 500 may analyze key components of this model, such as the base model (e.g., Llama 2) and the dataset used (e.g., “finance-chat”), by pulling data from the model card and evaluation metrics from GitHub. Additionally, the AI trust feed 500 may collect information about potential security vulnerabilities, such as jailbreaks and prompt injections, from external sources. Its internal dataset scanning service may evaluate fine-tuned datasets gathering important metrics related to toxicity and bias. This allows the AI trust feed 500 to generate comprehensive evaluation metrics, including model size, training parameters, and more.

The AI trust feed 500 may be used to discover lineages of models. For example, the AI trust feed 500 may trace the fine-tuning history of publicly available large language models, including over 1,000 fine-tuned versions of the Llama 2 model available in public repositories. These models may have been trained on toxic or biased data, making it crucial to track their origins. For example, the model Meditron-7b-chat may be a fine-tuned version of the meta-llama/Llama-2-7b-chat model, trained on the epfl-llm/meditron-7b dataset, specifically designed for medical dialogues. The AI trust feed 500 may also uncover vulnerabilities, such as jailbreaking, in fine-tuned models derived from downstream models. Dataset lineage discovery is similarly important, as models are frequently fine-tuned or trained on publicly available datasets for use in generative AI applications. For example, the Dolphin dataset, has been used in over 328 models. The AI trust feed 500 may extends discovery by aggregating data from a variety of sources, ensuring comprehensive dataset lineage tracking.

The AI trust feed 500 provides a holistic and integrated approach to managing and securing generative AI technologies. Some tools may only focus on isolated aspects such as model tracking, security, or compliance. The AI trust feed 500 may be a unified platform that consolidates these and many other functions. The AI trust feed 500 may allow organizations to monitor AI usage, mitigate risks, optimize AI investments, and ensure regulatory compliance-all in one platform. Furthermore, the AI trust feed's 500 approach of using generative AI to process and merge unstructured, semi-structured, and structured data enhances its ability to provide detailed and actionable insights across the AI ecosystem.

The AI trust feed 500 may be implemented within an enterprise environment and may be applicable with a plurality of different AI applications. In at least one embodiment, the AI trust feed 500 may be implement with onboarding and governance features for a plurality of different AI use cases or AI applications within an enterprise environment. An enterprise environment may use onboarding and governing features (for example, procedures) to ensure that AI tools are properly evaluated and comply with organizational standards. For instance, first, input details for an AI use case may be received by a system of the enterprise environment for onboarding and governance. The input details may include a description of the use case, the data needed, and the identification of the specific AI tool or model to be used. Subsequently, the system may select or chose an AI tool or model for retrieval from an AI asset knowledge base, such as AI trust feed 500. This metadata may include information about the tool's publisher reputation, compliance certifications, privacy assurances, data retention policies, and model training details, and/or the like.

Afterwards, the system may initiate a governance workflow. The governance workflow includes multiple stages of evaluation by various stakeholders. These stages may include dynamic vetting steps such as an initial analysis to assess the suitability of the AI tool or model for the specified use case. After the governance workflow, the system may conduct a legal review to ensure compliance with contractual, licensing, and legal requirements. The system may also perform an information security evaluation to assess security controls and data protection measures associated with the use case. Further, the system may implement a policy enforcement stage that verifies an alignment of the AI use case with the enterprise environment's AI governance policies.

Throughout the onboarding and governance process, the system may record decisions made by stakeholders at each stage—whether approvals or rejections—along with any comments or justifications. The system may implement or provide a recommendation (for example, to a user) for an implementation of a final decision for the AI use case based on the aggregated decisions from all workflow stages. Once a final decision is implemented, the system may create one or more policies to enforce the outcomes of the process.

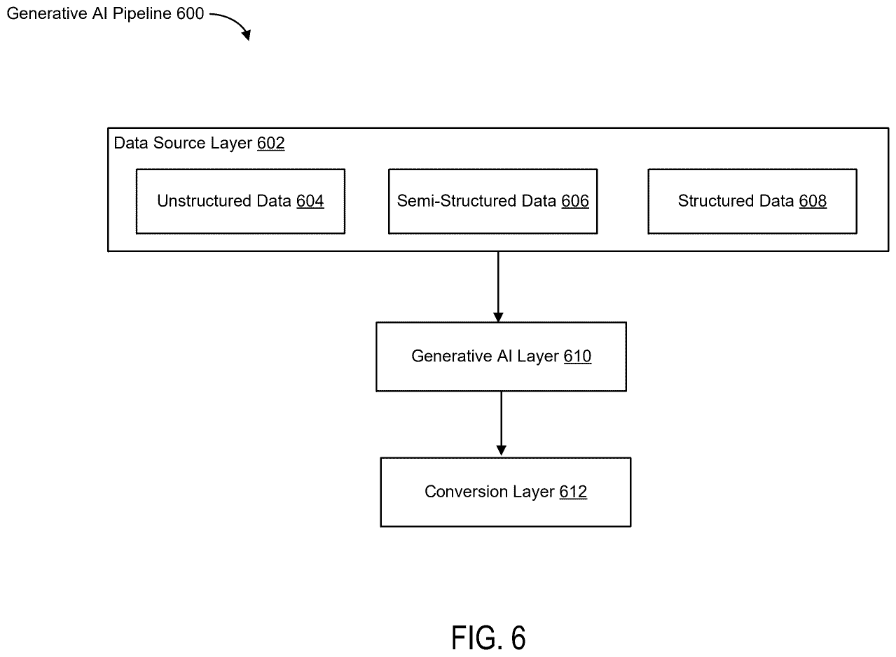

FIG. 6 illustrates an example generative AI pipeline 600 for implementing an AI trust feed, according to at least one embodiment. The generative AI pipeline 600 includes data layers having multiple components. The data source layers 602 include unstructured data 604, semi-structure data 606, and structured data 608. Unstructured data 604 may include AI websites and API documentation, utilizing both shallow and deep crawl approaches to gather data. Semi-structured data 606 may be drawn from APIs, which provide structured information as well as model documentation. Structured data 608 may handle marketplace data from AI service extensions, for example. The generative AI layer 610 may then convert unstructured data into embeddings, which are stored in a vector database (for example, vector store 520 of FIG. 5). The conversion layer 612 may fetch, convert, and store specific properties of data into a structured format, which is then stored in a database (for example, data store(s) 504 of FIG. 5). By consolidating these capabilities, the generative AI pipeline 600 may provide enterprises with a powerful tool to monitor, manage, and secure generative AI technologies in their operations, addressing both technical and security concerns in a rapidly changing AI landscape.

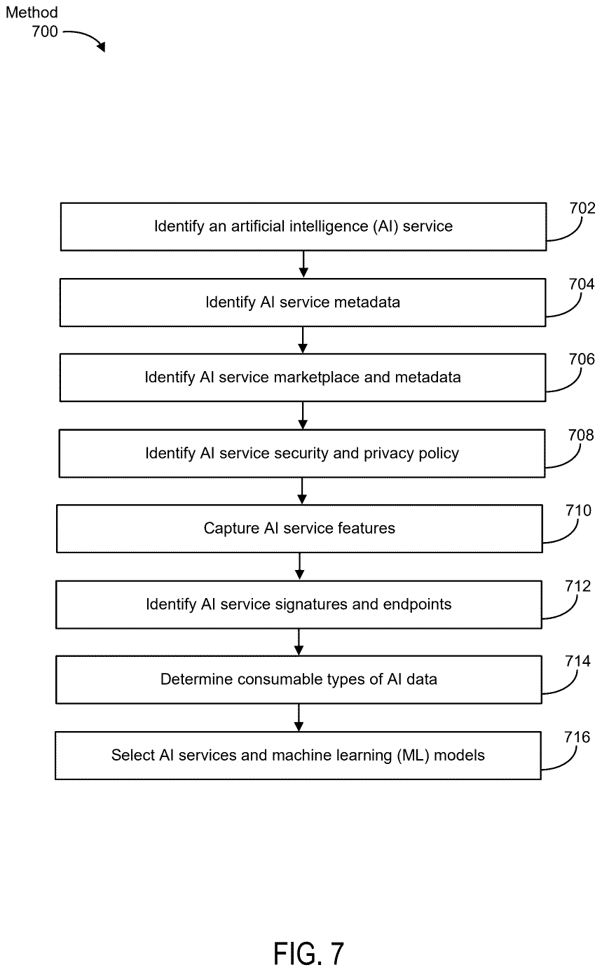

FIG. 7 illustrates an example AI service discovery method 700 for implementing with an AI trust feed, according to at least one embodiment. The step described herein, with respect to the method 700 of FIG. 7, may be performed by a platform such as platform 500 illustrated in FIG. 5. At step 702, AI services may be identified (for example, discovered or detected) within a customer's environment. For example, new AI service(s) may be identified periodically from AI marketplaces or through news feed alerts. At step 704, once a new AI service is identified, metadata related to the service may be identified. Metadata may include information about its publisher, company history, country of origin, and age. This information may be typically gathered by crawling the AI service's website.

At step 706, the AI service may be searched on various supported marketplaces-like browser extension stores, IDE extension stores, and app stores—to gather more metadata. This may be done in parallel with step 704. This may include details such as the publisher's verification status, store ratings, number of users, trusted app status, and required permissions. Additionally, the service's digital signatures, like DNS records on different marketplaces, may be captured. In at least one embodiment, security and privacy considerations are also critical. For example, at step 708, information about the service's security and privacy practices may be collected from both the website and marketplaces. This data may be consolidated to create an overall security and privacy profile, which may include the service's data retention policies and its adherence to relevant compliance frameworks. At step 710, detailed information may be captured about the AI service's features, including the different capabilities an AI service offers. At step 712, signatures of the AI service's various features and endpoints may be identified. These signatures may be analyzed for anomalies, considering factors such as file access, byte counts sent and received, and API calls. For example, an API signature might be observed when a code review feature or unit test generation is used within a service. At step 714, consumable types of AI data may be determined for use. This may be determined based on the service's tasks, such as recognizing when a user uploads a PDF to ChatGPT, indicating the service's ability to process such files, and/or the like. At step 716, alternate AI service and machine learning model may be selected and/or recommended. By maintaining an up-to-date trust feed, the platform can suggest lower-risk AI services as alternatives to high-risk or untrusted ones, ensuring safer and more reliable usage for customers.

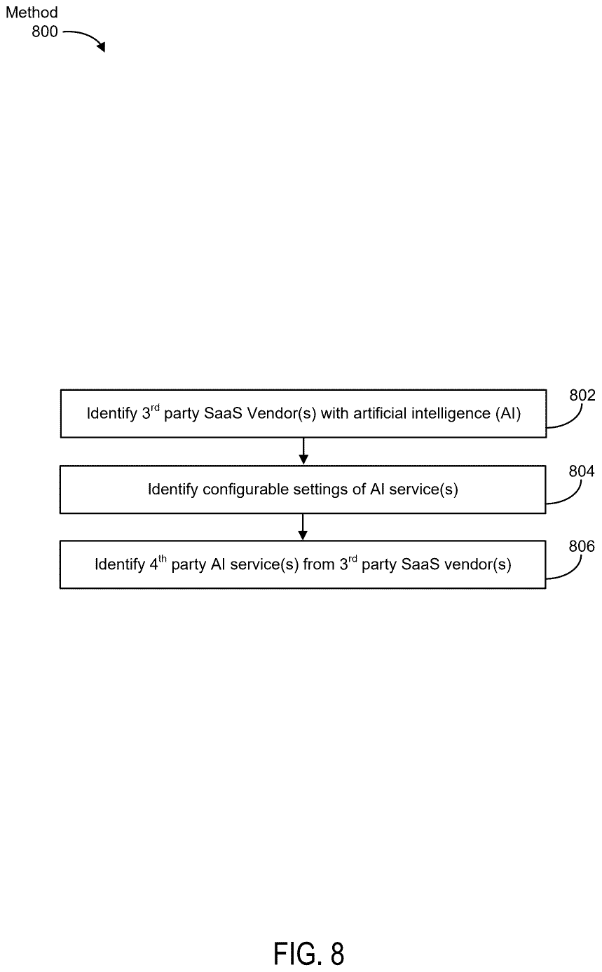

FIG. 8 illustrates an example 3^{rd} party AI SaaS vendor discovery method 800 for implementing with an AI trust feed, according to at least one embodiment. The step described herein, with respect to the method 800 of FIG. 8, may be performed by a platform such as platform 500 illustrated in FIG. 5. At step 802, the process of discovering third-party SaaS vendors with AI capabilities includes identifying any AI sub-processors used by these services. For example, if an SaaS provider introduces a chatbot feature that relies on an external AI service, this integration may be detected as part of the discovery process. Additionally, the platform may capture signatures of AI features embedded within these SaaS offerings to track the use and deployment of AI technologies. At step 804, the discovery process identifies the configurable settings of AI services within an organization. When an AI service is utilized as a SaaS product, access to its configuration settings is often available (depending on the service). For instance, in some services, configuration options may allow for the determination of whether meeting recordings are used to train AI models, providing insight into how the AI service is being utilized. At step 806, the discovery process also identifies fourth-party AI services that are being leveraged by third-party SaaS vendors. Many third-party SaaS vendors rely on external marketplaces to enable developers or other organizations to integrate their applications with the platform. These integrations often involve free applications that users can install and use, though these applications may also have access to organizational data. The risks associated with using these fourth-party vendors through the third-party SaaS platform may also be assessed, as these risks may expose the organization to additional security or privacy risks.

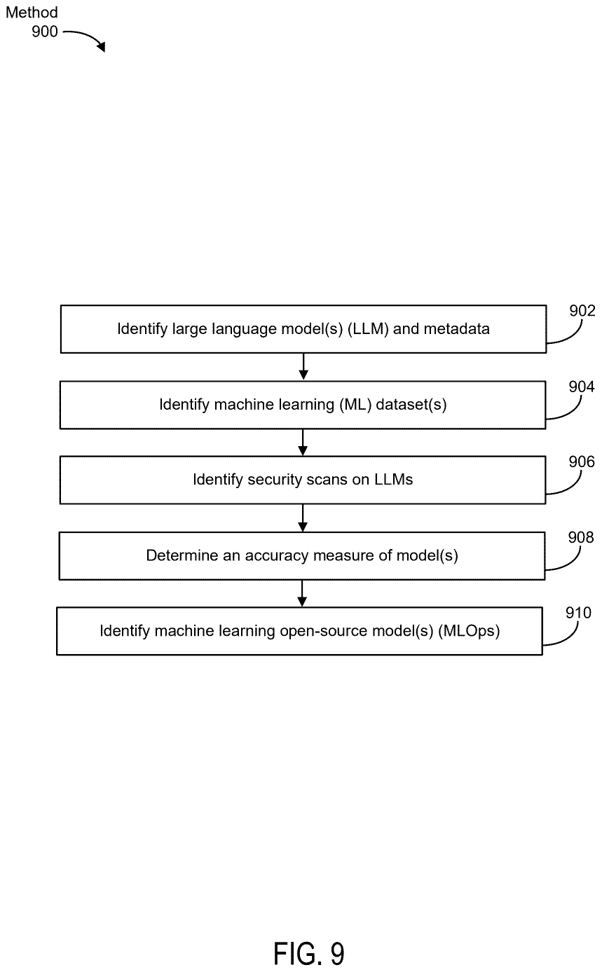

FIG. 9 illustrates an example large language model (LLM) and metadata discovery method 900 for implementing with an AI trust feed, according to at least one embodiment. The step described herein, with respect to the method 900 of FIG. 9, may be performed by a platform such as platform 500 illustrated in FIG. 5. At step 902, discovering large language models (LLMs) and their associated metadata may include identifying both open-source and closed-source LLMs. For open-source models, various model repositories may be utilized to locate these models. Once discovered, the metadata of each model is enriched with over 20 attributes gathered from the internet and various repositories. This metadata includes details such as the model's license, family, type, architecture, the number of known jailbreaks, and more. Generative AI may be used in multiple stages of this process to refine and enhance the data. Additionally, model cards from prominent AI cloud platforms may be fetched to further supplement the metadata. For closed-source models, information may be collected from well-known sources and white-papers to ensure comprehensive details are obtained.

At step 904, machine learning (ML) datasets may be identified through APIs provided by platforms. These APIs facilitate access to a wide range of datasets, enabling a more thorough exploration of the data used to train various models. At step 906, the discover process may include security scanning of LLMs. Methods may be implemented to uncover security scan results and vulnerability assessments for ML models. This may include identifying potential threats such as jailbreaks, prompt injections, and serialization attacks, which could compromise the integrity of the models. At step 908, to assess the performance of these models, accuracy metrics may be determined or retrieved from reputable sources, such as repositories and leaderboards on platforms. This may provide valuable insights into the effectiveness and reliability of the LLMs. At step 910, the discovery process may extend to machine learning open-source model(s) (MLOps), where deployed open-source models from AI platforms may be identified and accessed. This may include investigating and reporting on the latency measures of various models in MLOps environments and allowing for optimization of operational efficiency in AI systems.

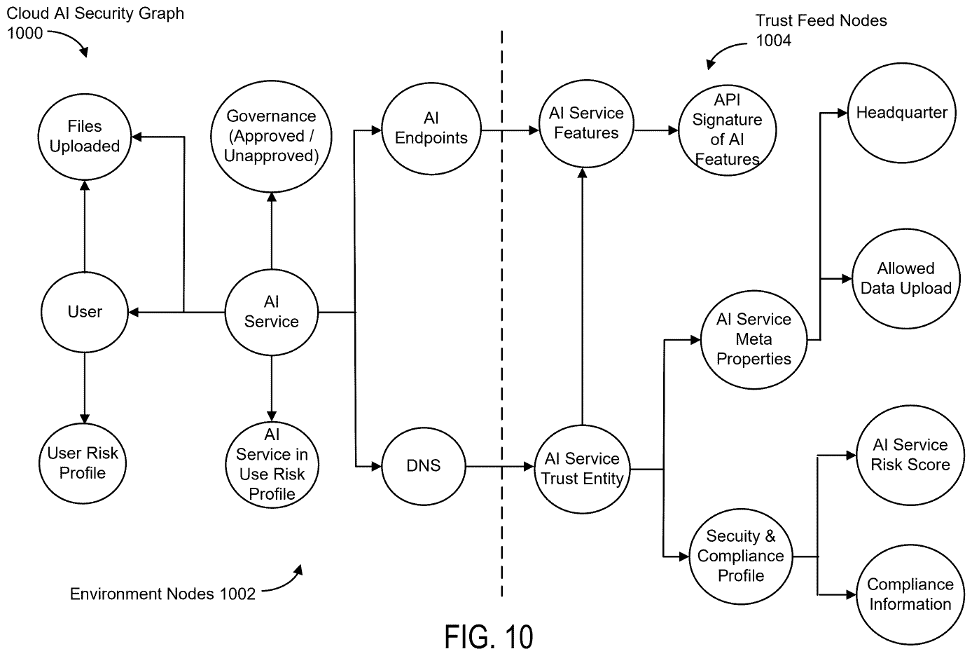

FIG. 10 illustrates an example cloud AI security graph 1000, according to at least one embodiment. As shown in FIG. 10, the cloud AI security graph 1000 includes environmental nodes 1002 and trust feed nodes 1004. The environment nodes 1002 may include a user node, a user risk profile, uploaded files, governance (approved/unapproved), AI service, AI service in use risk profile, AI endpoints, and a domain name system (DNS). The environment nodes 1002 may be associated with a system of an enterprise environment utilizing AI application(s). The trust feed nodes 1004 may include AI service features, AI service trust entity, API signature of AI features, AI service meta properties, security & compliance profile, headquarter, allowed data upload, AI service risk score, and compliance information. The trust feed nodes 1004 may be associated with the AI trust feed 506 illustrated in FIG. 5.

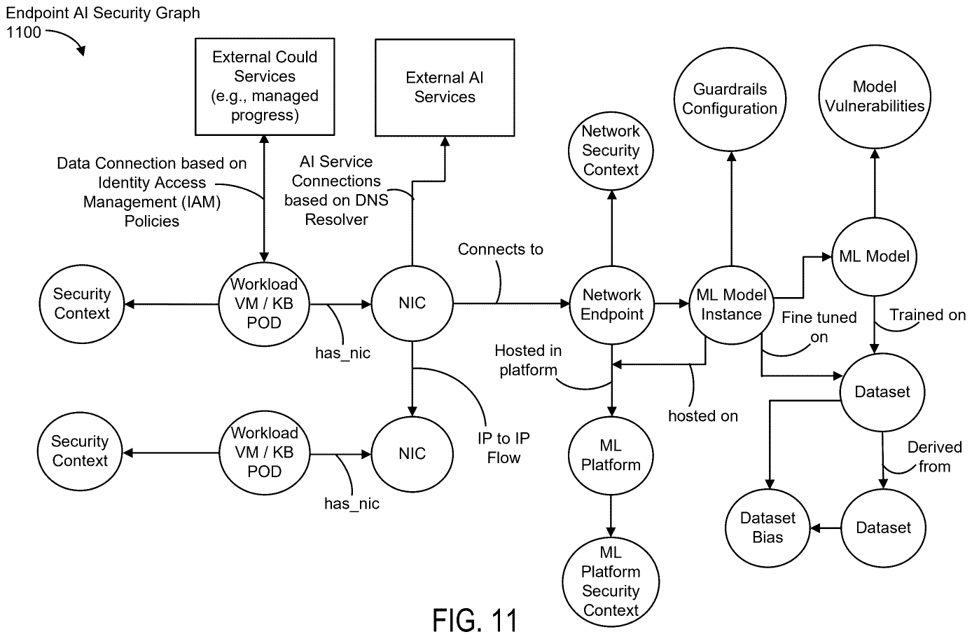

FIG. 11 illustrates an example endpoint AI security graph 1100, according to at least one embodiment. As shown in FIG. 11, the endpoint AI security graph 1100 may include security contexts, workload virtual machine (VM)/knowledge base (KB) PODs, external cloud services (e.g., managed progress), network internet cards (NICs), network endpoint, network security context, machine learning (ML) platform, ML platform security context, ML model instance, guardrails configuration, model vulnerabilities, ML models, datasets, and dataset bias. In at least one embodiment, the security context, the network security context, the ML platform, the ML platform security context, and the guardrails configuration may be associated with the infrastructure system 106 illustrated in FIGS. 1, 2, and 3. In at least one embodiment, the external AI sources, the model vulnerabilities, and the dataset bias may be associated with the AI trust feed 506 illustrated in FIG. 5. In at least one embodiment, the workload VM/KB POD, NICs, network endpoint, ML model instance, ML model, and datasets may be associated with a system of an enterprise environment utilizing AI application(s).

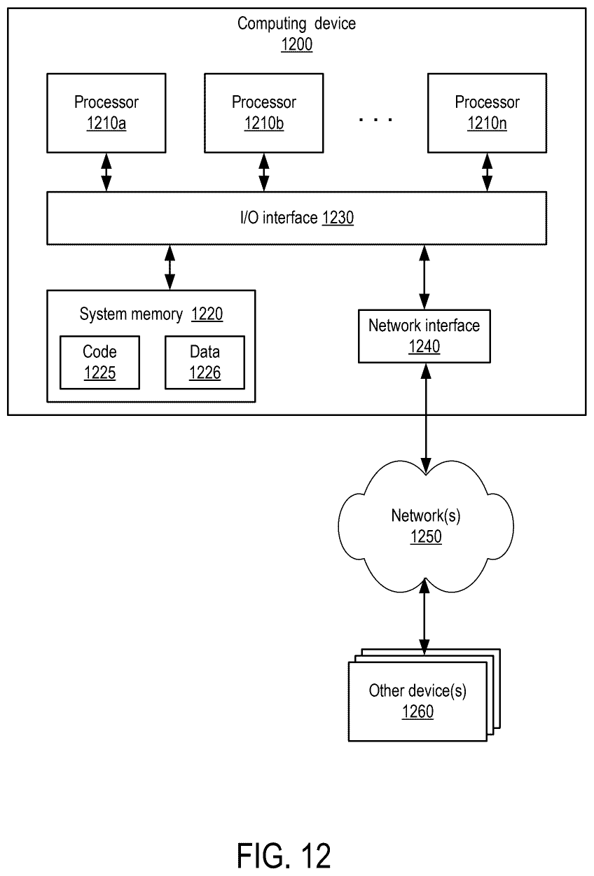

FIG. 12 is a block diagram illustrating an example computing device that may be used in at least some embodiments. In the illustrated embodiment, computing device 1200 includes one or more processors 1210 coupled to a system memory 1220 (which may comprise both non-volatile and volatile memory modules) via an input/output (I/O) interface 1230. Computing device 1200 further includes a network interface 1240 coupled to I/O interface 1230.

In various embodiments, computing device 1200 may be a uniprocessor system including one processor 1210, or a multiprocessor system including several processors 1210 (e.g., two, four, eight, or another suitable number). Processors 1210 may be any suitable processors capable of executing instructions. For example, in various embodiments, processors 1210 may be general-purpose or embedded processors implementing any of a variety of instruction set architectures (ISAs), such as the x86, PowerPC, SPARC, ARM, or MIPS ISAs, or any other suitable ISA. In multiprocessor systems, each of processors 1210 may commonly, but not necessarily, implement the same ISA. In some implementations, graphics processing units (GPUs) and or field-programmable gate arrays (FPGAs) may be used instead of, or in addition to, conventional processors.

System memory 1220 may be configured to store instructions and data accessible by processor(s) 1210. In at least some embodiments, the system memory 1220 may comprise both volatile and non-volatile portions; in other embodiments, only volatile memory may be used. In various embodiments, the volatile portion of system memory 1220 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 1220 as code 1225 and data 1226.

In one embodiment, I/O interface 1230 may be configured to coordinate I/O traffic between processor 1210, system memory 1220, and any peripheral devices in the device, including network interface 1240 or other peripheral interfaces such as various types of persistent and/or volatile storage devices. In some embodiments, I/O interface 1230 may perform any necessary protocol, timing or other data transformations to convert data signals from one component (e.g., system memory 1220) into a format suitable for use by another component (e.g., processor 1210). In some embodiments, I/O interface 1230 may include support for devices attached through various types of peripheral buses (including hardware accelerators of various kinds), such as a variant of the Peripheral Component Interconnect (PCI) bus standard or the Universal Serial Bus (USB) standard, for example. In some embodiments, the function of I/O interface 1230 may be split into two or more separate components, such as a north bridge and a south bridge, for example. Also, in some embodiments some or all of the functionality of I/O interface 1230, such as an interface to system memory 1220, may be incorporated directly into processor 1210.

Network interface 1240 may be configured to allow data to be exchanged between computing device 1200 and other devices 1260 attached to a network or networks 1250, such as other computer systems or devices as illustrated in FIG. 1 through FIG. 12, for example. In various embodiments, network interface 1240 may support communication via any suitable wired or wireless general data networks, such as types of Ethernet network, for example. Additionally, network interface 1240 may support communication via telecommunications/telephony networks such as analog voice networks or digital fiber communications networks, via storage area networks such as Fibre Channel SANs, or via any other suitable type of network and/or protocol.

In some embodiments, system memory 1220 may represent one embodiment of a computer-accessible medium configured to store at least a subset of program instructions and data used for implementing the methods and apparatus discussed in the context of FIG. 1 through FIG. 12. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 1200 via I/O interface 1230. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computing device 1200 as system memory 1220 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 1240. Portions or all of multiple computing devices such as that illustrated in FIG. 12 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device”, as used herein, refers to at least all these types of devices, and is not limited to these types of devices.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor comprising: one or more circuits to:
obtain a plurality of data items from at least one data source implementing one or more artificial intelligence based (AI-based) services;
identify linkages between two or more data items of the plurality of data items, wherein the linkages between the two or more items are based on a confidence score associated with an AI-based service of the one or more AI-based services and indicate a shared association with the AI-based service of the one or more AI based services;
identify one or more schema associated with the two or more data items; and
generate an AI security graph associated with the AI-based service according to the one or more schema.

2. The processor of claim 1, wherein identifying the linkages between the two or more data items comprises receiving a restricted set of data items and subsequently seeding the two or more data items based on the restricted set of data items.

3. The processor of claim 1, wherein the one or more circuits further to aggregate the data based on seeding and linking the data from the plurality of data sources, and wherein aggregating the data comprises filtering out duplicate data from the plurality of data items.

4. The processor of claim 1, wherein the at least one data source comprise a plurality of data sources, and wherein the one or more circuits further to identify linkages between two or more sets of data items from different data sources of the plurality of data sources based on the confidence score associated with the AI-based service of the one or more AI-based services and the shared association with the AI-based service of the one or more AI based services.

5. The processor of claim 1, wherein the schema comprises at least one of consumption workflows associated with the AI-based service, policy enforcement workflows associated with the AI-based service, data collection workflows associated with the AI-based service, entity linking associated with the AI-based service, or natural language querying associated with the AI-based service.

6. The processor of claim 1, wherein the one or more circuits further to implement one or more AI governance policies for the AI-based service according to the AI security graph.

7. The processor of claim 1, wherein the plurality of data items comprise unstructured data, semi-structured data, and structured data.

8. A system comprising: one or more processors to:
obtain a plurality of data items from at least one data source implementing one or more artificial intelligence based (AI-based) services;
identify linkages between two or more data items of the plurality of data items, wherein the linkages between the two or more items are based on a confidence score associated with an AI-based service of the one or more AI-based services and indicate a shared association with the AI-based service of the one or more AI based services;
identify one or more schema associated with the two or more data items; and
generate an AI security graph associated with the AI-based service according to the one or more schema.

9. The system of claim 8, wherein identifying the linkages between the two or more data items comprises receiving a restricted set of data items and subsequently seeding the two or more data items based on the restricted set of data items.

10. The system of claim 8, wherein the one or more processors further to aggregate the data based on seeding and linking the data from the plurality of data sources, and wherein aggregating the data comprises filtering out duplicate data from the plurality of data items.

11. The system of claim 8, wherein the at least one data source comprise a plurality of data sources, and wherein the one or more processors further to identify linkages between two or more sets of data items from different data sources of the plurality of data sources based on the confidence score associated with the AI-based service of the one or more AI-based services and the shared association with the AI-based service of the one or more AI based services.

12. The system of claim 8, wherein the schema comprises at least one of consumption workflows associated with the AI-based service, policy enforcement workflows associated with the AI-based service, data collection workflows associated with the AI-based service, entity linking associated with the AI-based service, or natural language querying associated with the AI-based service.

13. The system of claim 8, wherein the one or more processors further to implement one or more AI governance policies for the AI-based service according to the AI security graph.

14. A method, comprising:
obtaining a plurality of data items from at least one data source implementing one or more artificial intelligence based (AI-based) services;
identifying linkages between two or more data items of the plurality of data items, wherein the linkages between the two or more items are based on a confidence score associated with an AI-based service of the one or more AI-based services and indicate a shared association with the AI-based service of the one or more AI based services;
identifying one or more schema associated with the two or more data items; and
generating an AI security graph associated with the AI-based service according to the one or more schema.

15. The method of claim 14, wherein identifying the linkages between the two or more data items comprises receiving a restricted set of data items and subsequently seeding the two or more data items based on the restricted set of data items.

16. The method of claim 14, further comprising aggregating the data based on seeding and linking the data from the plurality of data sources, and wherein aggregating the data comprises filtering out duplicate data from the plurality of data items.

17. The method of claim 14, wherein the at least one data source comprise a plurality of data sources, and further comprising identifying linkages between two or more sets of data items from different data sources of the plurality of data sources based on the confidence score associated with the AI-based service of the one or more AI-based services and the shared association with the AI-based service of the one or more AI based services.

18. The method of claim 14, wherein the schema comprises at least one of consumption workflows associated with the AI-based service, policy enforcement workflows associated with the AI-based service, data collection workflows associated with the AI-based service, entity linking associated with the AI-based service, or natural language querying associated with the AI-based service.

19. The method of claim 14, further comprising implementing one or more AI governance policies for the AI-based service according to the AI security graph.

20. The method of claim 14, wherein the plurality of data items comprise unstructured data, semi-structured data, and structured data.
